(19) United States
(12) Patent Application Publication
(10) Pub. No.: US 2024/0135171 A1
(43) Pub. Date: Apr. 25, 2024

(54) COMPUTER-READABLE RECORDING MEDIUM STORING MACHINE LEARNING PROGRAM, MACHINE LEARNING METHOD, AND INFORMATION PROCESSING APPARATUS

(71) Applicant: Fujitsu Limited, Kawasaki-shi (JP)

(72) Inventors: Jun LIANG, Kawasaki (JP); Hajime MORITA, Kawasaki (JP)

(73) Assignee: Fujitsu Limited, Kawasaki-shi (JP)

(21) Appl. No.: 18/235,350

(22) Filed: Aug. 18, 2023

(30) Foreign Application Priority Data
Oct. 18, 2022 (JP) 2022-166696

(51) Int. Cl. G06N 3/08; G06N 3/045

(52) U.S. Cl. CPC G06N 3/08; G06N 3/045

(57) ABSTRACT

A process for machine learning processing of a machine learning model in which a natural language processing model and a classification model are combined, the process includes obtaining a first projection matrix that is obtained in an n-th iteration of the machine learning processing and that indicates a correspondence between input data input from the natural language processing model to the classification model and output data output from the classification model, updating a parameter of the natural language processing model, updating a parameter of the classification model by using the first projection matrix, and obtaining, in an n+1-th iteration of the machine learning processing, a second projection matrix that indicates a correspondence between input data input from the updated natural language processing model to the updated classification model and output data output from the updated classification model, wherein the n is a natural number.

### CROSS-REFERENCE TO RELATED APPLICATION

This application is based upon and claims the benefit of priority of the prior Japanese Patent Application No. 2022-166696, filed on Oct. 18, 2022, the entire contents of which are incorporated herein by reference.

### FIELD

The embodiments discussed herein is related to a computer-readable recording medium storing a machine learning program and the like.

### BACKGROUND

In natural language processing, there is a technique called domain adaptation. For example, the domain adaptation is a technique to perform a task of reducing a domain shift between samples of a source domain and a target domain.

FIG. 6 is a diagram illustrating an example of data distribution in domains. In the example illustrated in FIG. 6, data 10 of an original language model (LM) domain, data 11 of a target domain, and data 12 of a target domain downstream task are included in a space.

The data 10 of the original LM domain corresponds to data of sentences existing in the Internet. The data 11 of the target domain is corpus data of the target domain. The data 12 of the target domain downstream task is data of a sentence selected to execute a downstream task.

Hereinafter, an example of a technique of related art of the domain adaptation using the data 10 of the original LM domain, data 11 of the target domain, and the data 12 of the target domain downstream task is described.

FIG. 7 is a diagram for explaining the technique of related art of the domain adaptation. For example, processing is executed in order of step S10, step S11, and step S12 in the domain adaptation with the technique of related art. An apparatus of related art that executes the domain adaptation is represented as the related-art apparatus.

In step S10, the related-art apparatus trains a first model 10a (pretrained language model) by using the data 10 of the original LM domain. The first model 10a is a natural language processing model. The first model 10a is realized by a neural network (NN) or the like. For example, when a sentence is input to the first model 10a, vectors of words included in the sentence are output.

In step S11, the related-art apparatus retrains the first model 10a by using the data 11 of the target domain so as to obtain a second model 11a (re-pretrained language model).

In step S12, the related-art apparatus couples the second model 11a to a named entity recognition (NER) model 12a and fine-tunes the second model 11a and the NER model 12a by using the data 12 of the target domain downstream task. The NER model 12a is a classification model. The NER model 12a is, for example, an NN.

Next, an example of a problem caused in data classification is described. FIG. 8 is a diagram for explaining a problem caused in the data classification. In the example illustrated in FIG. 8, the domains are an “Electronic medical records domain” and a “Disease explanation documents domain”. The classes a “Person” and a “B-Disease” are present. A sentence 15 is set as “Behcet's disease is globalized and infectious”.

For example, in a case where the sentence 15 and a sentence belonging to the “Person” are similar to each other and the sentence 15 and a sentence belonging to the “B-Disease” are similar to each other, the sentence 15 is not necessarily successfully classified. Wrong classification of the sentence 15 leads to a situation in which a domain to which the sentence 15 belongs is wrong. As a result, the data distribution in the domain becomes unknown, and the difference in data distribution between the two domains the “Electronic medical records domain” and the “Disease explanation documents domain” becomes unknown.

Meanwhile, in a case where the domain adaptation is performed, a projection matrix that indicates the correspondence between data on the source domain side and data on the target domain side may be trained. When the difference in data distribution between the source domain side and the target domain side (domain data distribution shift) is clarified, the projection matrix may be appropriately trained.

A domain discrepancy is to determine the difference in distribution between data of a domain and data of another domain. FIGS. 9 and 10 are diagrams illustrating an example of the domain adaptation with the domain discrepancy.

FIG. 9 is described. For example, a data group 10s is data on the source domain side belonging to a class C₁. A data group 10t is data on the target domain side belonging to a class C₁. A data group 11s is data on the source domain side belonging to a class C₂. A data group 11t is data on the target domain side belonging to a class C₂.

The data groups 10s, 10t, 11s, and 11t are pieces of data similar to each other. For example, when the domain adaptation is executed with a joint maximum mean discrepancy (MMD) method on the data groups 10s, 10t, 11s, and 11t, the data of the classes C₁ and C₂ is not successfully classified. When data is not necessarily successfully classified as described above, the difference in data distribution between two domains is not necessarily successfully calculated, and the domain adaptation is not necessarily appropriately executed.

FIG. 10 is described. For example, a data group 12s is data on the source domain side belonging to the class C₁. A data group 12t is data on the target domain side belonging to a class C₁. A data group 13s is data on the source domain side belonging to a class C₂. A data group 13t is data on the target domain side belonging to a class C₂.

The data groups 12s and 12t are pieces of data similar to each other. The data groups 13s and 13t are pieces of data similar to each other. The data group 12s and the data group 13t are pieces of data not similar to each other. The data group 12t and the data group 13s are pieces of data not similar to each other. For example, when the domain adaptation is executed with a discriminative joint probability (DJP) MMD method on the data groups 12s, 12t, 13s, and 13t, the data of the classes C₁ and C₂ may be successfully classified. When data is successfully classified as described above, the difference in data distribution between two domains may be successfully calculated, and the domain adaptation may be appropriately executed.

For example, according to the DJP-MMD method, a distance d between a data distribution D s of the source domain and a data distribution D t of the target domain is calculated by using Expression (1). In Expression (1), “μ” is a trade-off parameter.

d(Dₛ,Dₜ)=M_{T}−μM_{D} (1)

In Expression (1), “M_{D}” indicates a discriminability between the source domain and the target domain. For example, M_{D} is defined by Expression (2).

$${M}_{D} = {\sum }_{c \neq c ′} {\sum }_{{c}^{′} = 1}^{C} {‖ \frac{1}{{n}_{s}} {\sum }_{i = 1}^{{n}_{s}^{c}} {A}^{⊤} {ϰ}_{s , i}^{c} - \frac{1}{{n}_{t}} {\sum }_{j = 1}^{{n}_{t}^{c ′}} {A}^{⊤} {ϰ}_{t , j}^{c ′} ‖}_{2}^{2} \qquad ( 2 )$$

In Expression (2), “c” is a label set of the source domain, “c′” is a label set of the target domain, “X^{c}_{s,i}” is a feature vector of the source domain in the cth class, “X_{c}^{t,i}” is a feature vector of the target domain in the cth class, “n^{c}ₛ” is the number of examples in the source domain of the cth class, “n^{c}ₜ” is the number of examples in the target domain of the cth class, and “A” is the projection matrix.

Meanwhile, in Expression (1), “M_{T}” indicates a transferability between the source domain and the target domain. For example, M_{T} is defined by Expression (3).

$$\begin{matrix}{M}_{T} = {\sum }_{c = 1}^{C} d ( P ( {X}_{s} \vert {Y}_{s}^{c} ) P ( {Y}_{s}^{c} ) , P ( {X}_{t} \vert {Y}_{t}^{c} ) P ( {Y}_{t}^{c} ) ) \\ = {\sum }_{c = 1}^{C} {‖ 𝔼 [ f ( {ϰ}_{s} ) \vert {y}_{s}^{c} ] P ( {y}_{s}^{c} ) - 𝔼 [ f ( {ϰ}_{t} ) \vert {y}_{t}^{c} ] P ( {y}_{t}^{c} ) ‖}^{2}\end{matrix} \qquad ( 3 )$$

In Expression (3), “Xₛ” is source domain data, “Yₛ^{c}” is a source domain label, “Xₜ” is target domain data, and “Yₜ^{c}” is a target domain label.

In Expression (3), “E” is defined by Expression (4), and “P” is defined by Expression (5).

$$𝔼 [ f ( {ϰ}_{s} ) \vert {y}_{s}^{c} ] = \frac{1}{{n}_{s}^{c}} {\sum }_{i = 1}^{{n}_{s}^{c}} {A}^{⊤} {ϰ}_{s , i ′}^{c} \qquad ( 4 )$$

$$P ( {y}_{s}^{c} ) = \frac{{n}_{s}^{c}}{{n}_{s}} \qquad ( 5 )$$

Next, an example of machine learning processing for a machine learning model of related art in which a natural language model and a classification model are combined is described. FIG. 11 is a diagram for explaining the machine learning processing of the machine learning model of related art. As illustrated in FIG. 11, a machine learning model 25 includes a natural language model 20 and a classification model 21. An output result of the natural language model 20 is input to the classification model 21.

The natural language model 20 is a language model such as bidirectional encoder representations from transformers (BERT). When data 20a of a sentence including a plurality of words is input to the natural language model 20, Xₛ is output from the natural language model 20. For example, Xₛ is a vector or the like of each word.

The classification model 21 is a classification model such as a feedforward neural network (FNN). When an output result (for example, Xₛ) of the natural language model 20 is input to the classification model 21, a label “Y′ₛ” is output from the classification model 21.

In the machine learning processing for the machine learning model 25, the classification model 21 is fine-tuned such that a loss between the label “Y′ₛ” output from the classification model 21 and the ground truth “Yₛ” reduces.

In the machine learning processing for the machine learning model 25, parameters of the natural language model 20 are fixed, and thereby the output result Xₛ of the natural language model 20 is fixed. The projection matrix A is trained from the relationship between Xₛ input to the classification model 21 and “Y′ₛ” output from the classification model 21. For example, the projection matrix A is trained based on a joint probabilistic data association (JPDA) algorithm.

Japanese National Publication of International Patent Application No. 2020-520505 is disclosed as related art.

### SUMMARY

According to an aspect of the embodiments, a non-transitory computer-readable recording medium storing a machine learning program for causing a computer to execute a process for machine learning processing of a machine learning model in which a natural language processing model and a classification model are combined, the process includes obtaining a first projection matrix that is obtained in an n-th iteration of the machine learning processing and that indicates a correspondence between input data input from the natural language processing model to the classification model and output data output from the classification model, updating a parameter of the natural language processing model, updating a parameter of the classification model by using the first projection matrix, and obtaining, in an n+1-th iteration of the machine learning processing, a second projection matrix that indicates a correspondence between input data input from the updated natural language processing model to the updated classification model and output data output from the updated classification model, wherein the n is a natural number.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram for explaining processing of an information processing apparatus according to an embodiment;

FIG. 2 is a diagram for explaining an effect of the information processing apparatus according to the embodiment;

FIG. 3 is a functional block diagram illustrating the configuration of the information processing apparatus according to the embodiment;

FIG. 4 is a flowchart illustrating a processing procedure of machine learning processing of a machine learning model;

FIG. 5 is a diagram illustrating an example of a hardware configuration of a computer that realizes the functions similar to those of the information processing apparatus according to the embodiment;

FIG. 6 is a diagram illustrating an example of data distribution in domains;

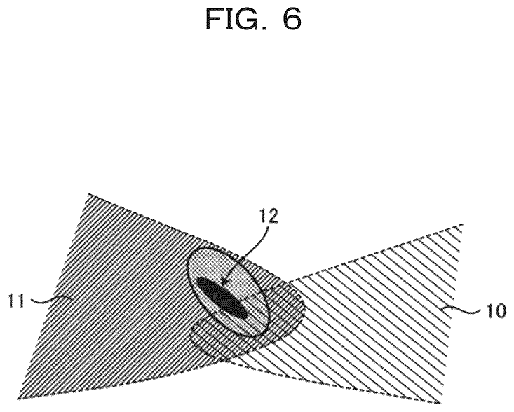

FIG. 7 is a diagram for explaining the technique of related art of domain adaptation;

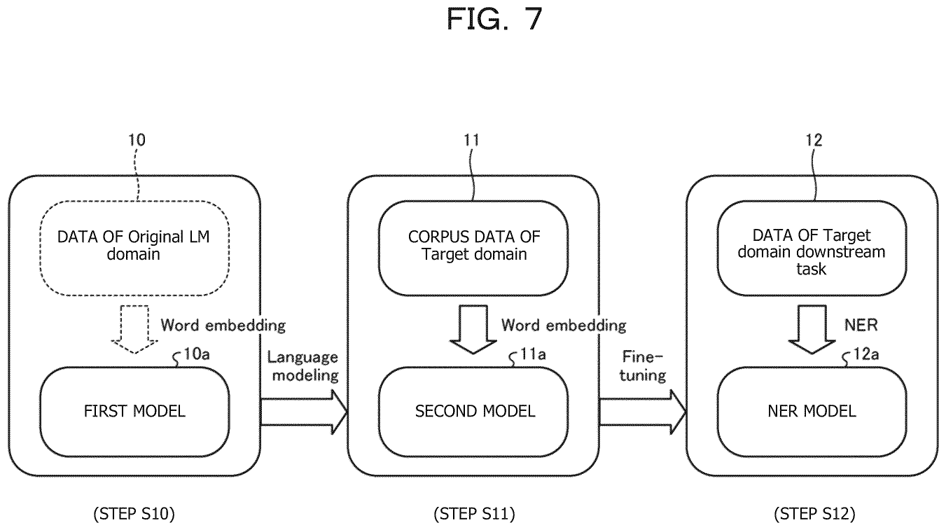

FIG. 8 is a diagram for explaining a problem caused in data classification;

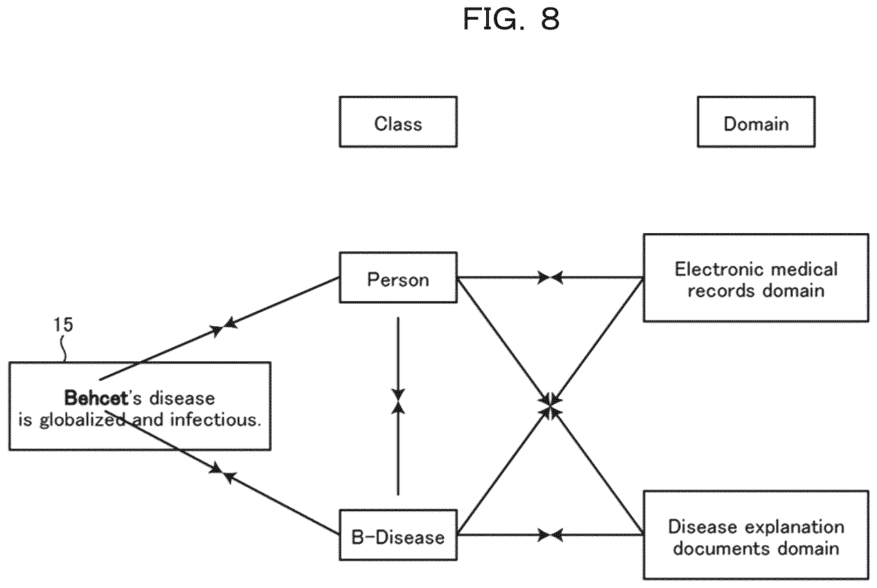

FIG. 9 is a diagram (1) illustrating an example of the domain adaptation with a domain discrepancy;

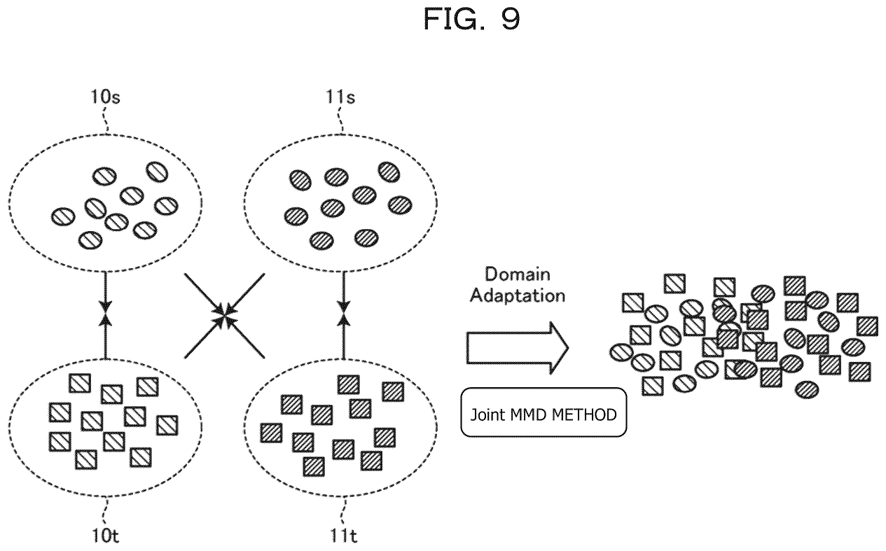

FIG. 10 is a diagram (2) illustrating an example of the domain adaptation with the domain discrepancy; and

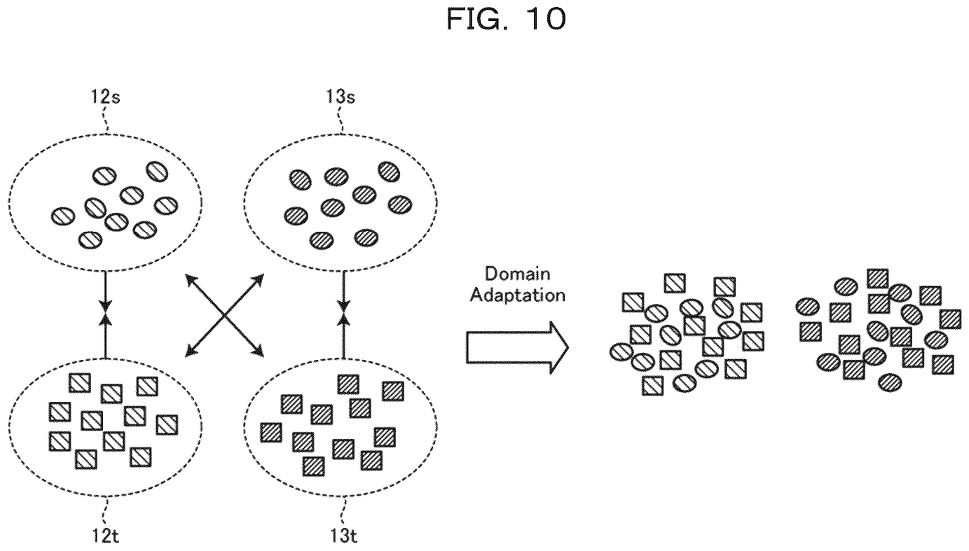

FIG. 11 is a diagram for explaining the machine learning processing of the machine learning model of related art.

### DESCRIPTION OF EMBODIMENTS

According to the technique of related art described above, in a case where the machine learning model in which the natural language model and the classification model are coupled is fine-tuned, parameters of only a small number of layers of the machine learning model are updated.

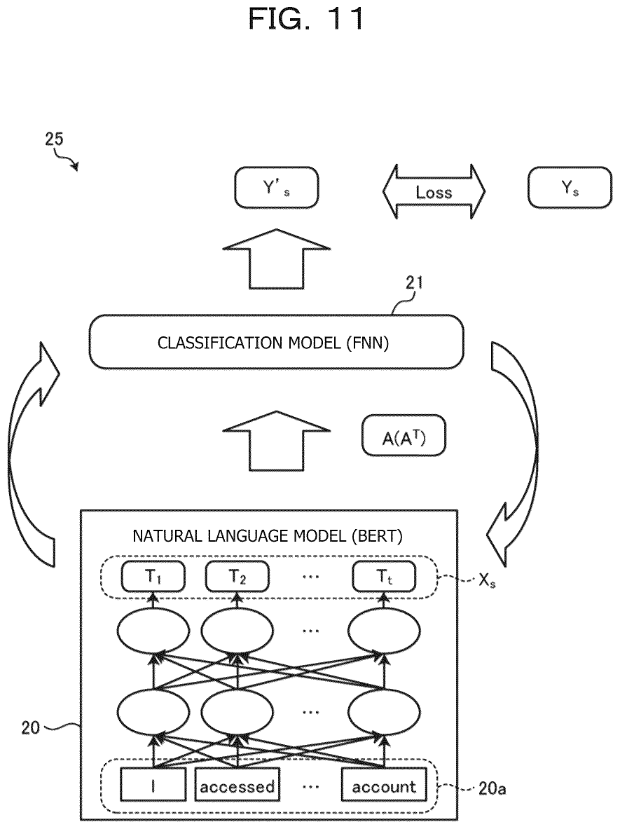

For example, in the machine learning model 25 illustrated in FIG. 11, the value of Xₛ is fixed for training the projection matrix A. To fix the value of Xₛ, the parameters of the natural language model 20 are fixed, and only the parameters of the classification model 21 are updated. As a result, the difference in data distribution between the domain on the input side of the classification model 21 and the domain on the output side of the classification model 21 is not necessarily sufficiently calculated. This leads to degradation of the performance of the machine learning model 25.

When the parameters of the natural language model 20 are simply updated, the value of Xₛ is not fixed, and the projection matrix A is unable to be trained.

Embodiments of techniques capable to allow update of parameters of the entirety of a machine learning model in which a natural language model and a classification model are coupled will be described in detail below with reference to the drawings. This disclosure is not limited by the embodiments.

### Embodiments

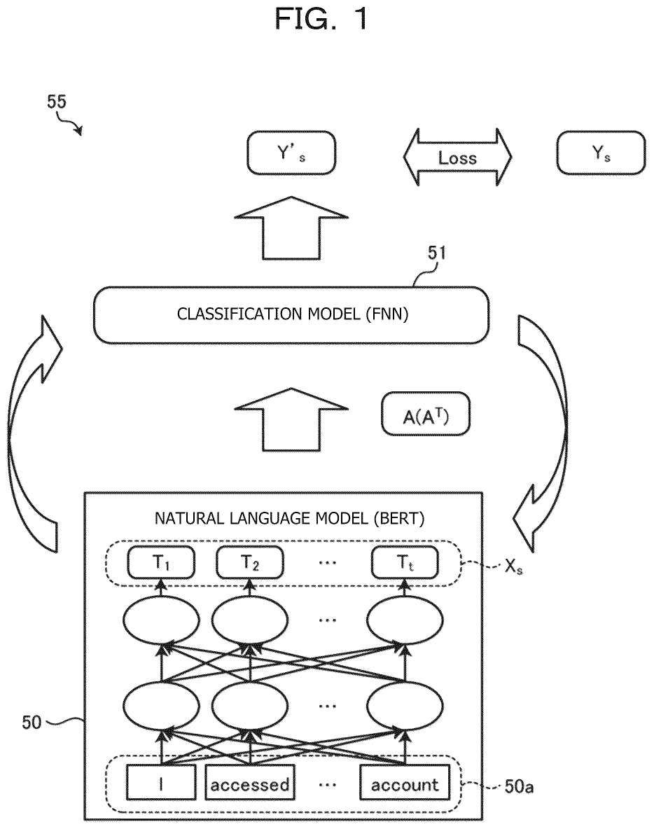

FIG. 1 is a diagram for explaining processing of the information processing apparatus according to the embodiment. As illustrated in FIG. 1, the information processing apparatus includes a machine learning model 55. The machine learning model 55 includes a natural language model 50 and a classification model 51. An output result of the natural language model 50 is input to the classification model 51.

The natural language model 50 is a language model such as bidirectional encoder representations from transformers (BERT). When data 50a of a sentence including a plurality of words is input to the natural language model 50, Xₛ is output from the natural language model 50. For example, Xₛ is a vector or the like of each word included in the sentence.

The classification model 51 is a classification model such as a feedforward neural network (FNN). When an output result (for example, Xₛ) of the natural language model 50 is input to the classification model 51, a label “Y′ₛ” is output from the classification model 51.

The information processing apparatus executes machine learning processing of the machine learning model 55 as follows. The information processing apparatus fine-tunes the natural language model 50 in an nth iteration. The fine-tuning of the natural language model 50 is unsupervised training using training data prepared in advance. For example, training data used in the unsupervised training is data of a sentence belonging to the source domain. The natural language model 50 fine-tuned in the nth iteration is represented as a “natural language model 50-n”.

The information processing apparatus also fine-tunes the classification model 51 in the nth iteration. The fine-tuning of the classification model 51 is supervised training using training data in which input “Xₛ” and the ground truth “Yₛ” are defined. The information processing apparatus inputs Xₛ (output of the natural language model 50-n) to the classification model 51 and fine-tunes the classification model 51 such that a loss between the label “Y′ₛ” output from the classification model 51 and the ground truth “Yₛ” reduces.

The information processing apparatus trains a projection matrix An from the correspondence between Xₛ (output from the natural language model 50-n) and the output Y′ₛ of the classification model 51.

The information processing apparatus fine-tunes the classification model 51 by using “Xₜ” prepared in advance. Since the ground truth “Yₜ” corresponding to “Xₜ” is not prepared in advance, the ground truth “Yₜ” is calculated by using the relationship between the projection matrix An and “Yₜ=A(A^{T})×Xₜ”. The information processing apparatus inputs Xₜ to the classification model 51 and fine-tunes the classification model 51 such that a loss between “Y′ₜ” output from the classification model 51 and the ground truth “Yₜ” reduces. The classification model 51 fine-tuned in the nth iteration is represented as a “classification model 51-n”.

In the above-described nth iteration, the projection matrix An, the natural language model 50-n, and the classification model 51-n are trained.

Next, the information processing apparatus fine-tunes the natural language model 50-n in an n+1th iteration. The natural language model 50 fine-tuned in the n+1th iteration is represented as a “natural language model 50-n+1”.

The information processing apparatus fine-tunes the classification model 51-n in the n+1th iteration. The information processing apparatus inputs Xₛ (output of the natural language model 50-n+1) to the classification model 51-n and fine-tunes the classification model 51-n such that the loss between “Y′ₛ” output from the classification model 51 and the ground truth “Yₛ” reduces.

The information processing apparatus trains a projection matrix An+1 from the correspondence between Xₛ (output from the natural language model 50-n+1) and the output Y′ₛ of the classification model 51-n.

The information processing apparatus fine-tunes the classification model 51-n by using “Xₜ” prepared in advance. Since the ground truth “Yₜ” corresponding to “Xₜ” is not prepared in advance, the ground truth “Yₜ” is calculated by using the relationship between the projection matrix An+1 and “Yₜ=A(A^{T})×Xₜ”. The information processing apparatus inputs Xₜ to the classification model 51-n and fine-tunes the classification model 51-n such that the loss between “Y′ₜ” output from the classification model 51-n and the ground truth “Yₜ” reduces. The classification model 51 fine-tuned in the n+1th iteration is represented as a “classification model 51-n+1”.

In the above-described n+1th iteration, the projection matrix An+1, the natural language model 50-n+1, and the classification model 51-n+1 are trained.

The information processing apparatus repeatedly executes the above-described processing for iterations after the n+1th iteration to fine-tune the natural language model 50 and the classification model 51 for the individual iterations.

As described above, the information processing apparatus according to the embodiment fine-tunes the natural language model 50 and the classification model 51 in the nth iteration and trains the projection matrix An from the correspondence between the input and the output of the classification model 51-n. The information processing apparatus fine-tunes the natural language model 50-n and the classification model 51-n in the n+1th iteration and trains the projection matrix An+1 from the correspondence between the input and the output of the classification model 51-n+1. Accordingly, the projection matrix A may be trained while the parameters of the entirety of the machine learning model 25 are updated. Furthermore, since the entirety of the machine learning model 55 may be updated, the performance may be improved compared to that of the machine learning model 25 described with reference to FIG. 11.

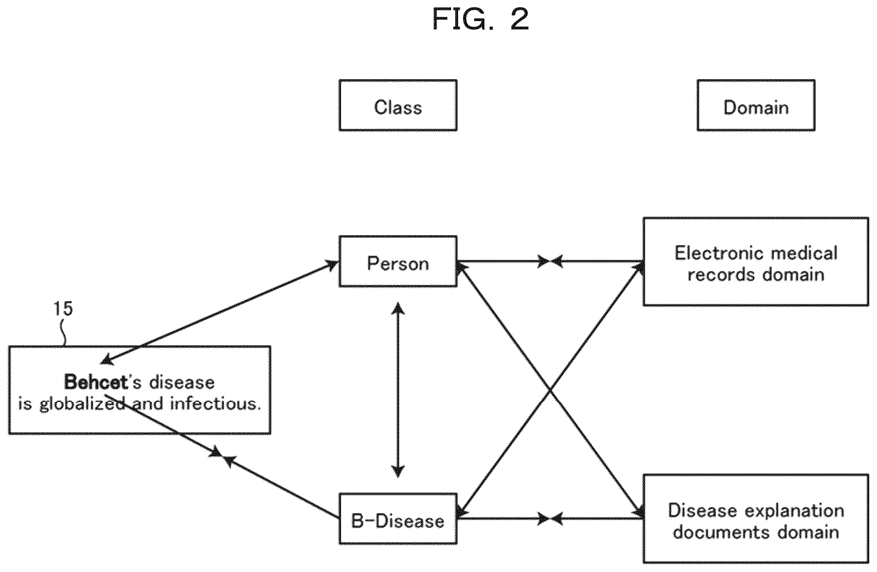

FIG. 2 is a diagram for explaining an effect of the information processing apparatus according to the embodiment. In an example illustrated in FIG. 2, the domains are set as “Electronic medical records domain” and “Disease explanation documents domain”. Also, there are classes “Person” and “B-Disease”. The sentence 15 is set as “Behcet's disease is globalized and infectious”.

For example, even when the sentence 15 and a sentence belonging to the “Person” are similar to each other and the sentence 15 and a sentence belonging to the “B-Disease” are similar to each other, classification into an appropriate class may be performed through the machine learning processing illustrated in FIG. 1. With the above-described machine learning processing, when it is assumed that “Behcet's” in the sentence 15 is known as the name of a patient, the class “Person” is output by inputting the sentence 15 to the machine learning model 55. For example, the performance of the machine learning model 25 is improved, and the domain adaptation may be appropriately executed.

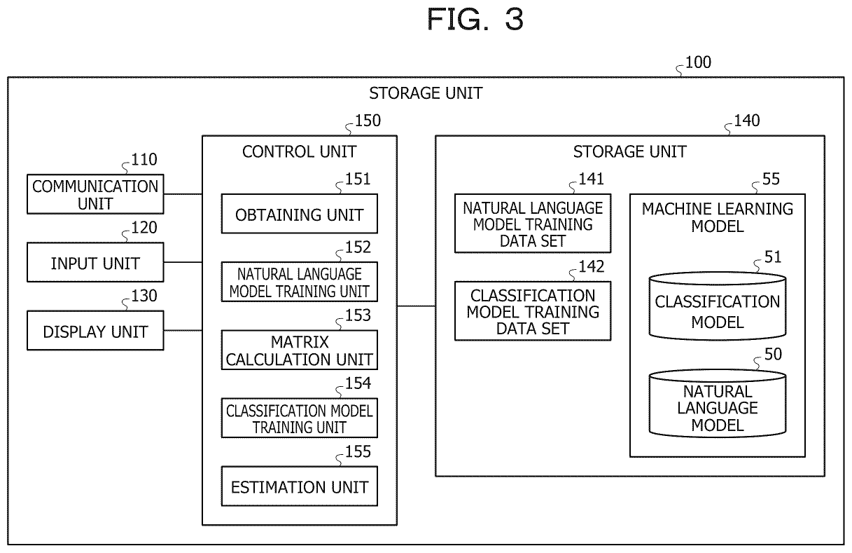

Next, a configuration example of the information processing apparatus that executes the processing illustrated in FIG. 1 is described. FIG. 3 is a functional block diagram illustrating the configuration of the information processing apparatus according to the embodiment. As illustrated in FIG. 2, an information processing apparatus 100 includes a communication unit 110, an input unit 120, a display unit 130, a storage unit 140, and a control unit 150.

The communication unit 110 executes data communication with an external apparatus or the like via a network. The control unit 150 to be described later exchanges data with the external apparatus via the communication unit 110.

The input unit 120 is an input device that allows input of various types of information to the control unit 150 of the information processing apparatus 100. The input unit 120 corresponds to a keyboard, a mouse, a touch panel, or the like.

The display unit 130 is a display device that displays information output from the control unit 150.

The storage unit 140 includes the machine learning model 55, a natural language model training data set 141, and a classification model training data set 142. The storage unit 140 is a storage device such as memory.

The machine learning model 55 includes the natural language model 50 and the classification model 51. The natural language model 50 is a language model such as BERT. The classification model 51 is a classification model such as an FNN.

The natural language model training data set 141 includes data for fine-tuning the natural language model 50. For example, the natural language model training data set includes data of a plurality of sentences belonging to the source domain.

The classification model training data set 142 includes a plurality of pieces of training data. A set of input data to be input to the machine learning model 55 and the ground truth (Yₛ) are set for each piece of the training data. A plurality of pieces of data of Xₜ may be set in the classification model training data set 142 other than the above-described training data.

The control unit 150 includes an obtaining unit 151, a natural language model training unit 152, a matrix calculation unit 153, a classification model training unit 154, and an estimation unit 155. The control unit 150 is a central processing unit (CPU), a graphics processing unit (GPU), or the like.

The obtaining unit 151 obtains various types of data from the external apparatus or the like. For example, the obtaining unit 151 obtains the natural language model training data set 141, the classification model training data set 142, and the like from the external apparatus and registers them in the storage unit 140.

Based on the natural language model training data set 141, the natural language model training unit 152 fine-tunes the natural language model 50 (updates parameters of the natural language model 50). For example, the natural language model training unit 152 inputs a sentence to the natural language model 50 and executes unsupervised training.

The matrix calculation unit 153 calculates the projection matrix A based on the relationship between Xₛ input to the classification model 51 and Y e output from the classification model 51.

Based on the classification model training data set 142, the classification model training unit 154 fine-tunes the classification model 51 (updates parameters of the classification model 51). For example, the classification model training unit 154 inputs, to the classification model 51, Xₛ obtained by inputting the input data to the natural language model 50. The classification model training unit 154 updates the parameters of the classification model 51 such that the loss between the label “Y′ₛ” output from the classification model 51 and the ground truth “Yₛ” reduces.

The classification model training unit 154 fine-tunes the classification model 51 by using “Xₜ”. Since the ground truth “Yₜ” corresponding to “Xₜ” is not prepared in advance, the classification model training unit 154 calculates the ground truth “Yₜ” by using the relationship between the projection matrix A and “Yₜ=A(A^{T})×Xₜ”. The classification model training unit 154 inputs Xₜ to the classification model 51 and updates the parameters of the classification model 51 such that the loss between “Y′ₜ” output from the classification model 51 and the ground truth “Yₜ” reduces.

Based on the fine-tuned machine learning model 55, the estimation unit 155 estimates a class to which the sentence belongs. For example, the estimation unit 155 obtains data of the sentence from the input unit 120. The estimation unit 155 inputs the obtained data of the sentence to the machine learning model 55 to obtain a classification result. The estimation unit 155 causes the display unit 130 to display the classification result.

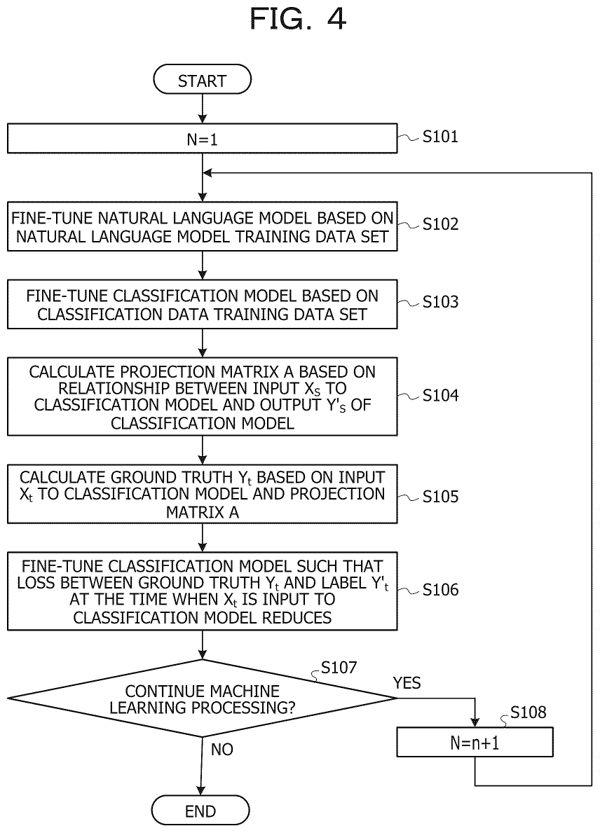

Next, an example of a processing procedure of the information processing apparatus 100 according to the embodiment is described. For example, the natural language model training unit 152, the matrix calculation unit 153, and the classification model training unit 154 that have been described above execute the machine learning processing of the machine learning model 55 in accordance with the processing procedure illustrated in FIG. 4.

FIG. 4 is a flowchart illustrating the processing procedure of the machine learning processing of the machine learning model. As illustrated in FIG. 4, the information processing apparatus 100 sets iteration N to 1 (operation S101). Based on the natural language model training data set 141, the natural language model training unit 152 of the information processing apparatus 100 fine-tunes the natural language model 50 (operation S102).

Based on the classification model training data set 142, the classification model training unit 154 of the information processing apparatus 100 fine-tunes the classification model 51 (operation S103).

The matrix calculation unit 153 of the information processing apparatus 100 calculates the projection matrix A based on the relationship between Xₛ that is the input to the classification model 51 and Y′ₛ that is the output from the classification model 51 (operation S104).

Based on Xₜ that is the input to the classification model 51 and the projection matrix A, the classification model training unit 154 calculates the ground truth Yₜ (operation S105). The classification model training unit 154 fine-tunes the classification model 51 such that the loss between the label “Y′ₜ” at the time when Xₜ is input to the classification model 51 and the ground truth “Yₜ” reduces (operation S106).

In a case where the machine learning processing is continued (Yes in operation S107), the information processing apparatus 100 add 1 to N (operation S108) and proceeds to operation S102. In contrast, in a case where the machine learning processing is not continued (No in operation S107), the information processing apparatus 100 ends the process.

Next, effects of the information processing apparatus 100 according to the embodiment are described. The information processing apparatus 100 fine-tunes the natural language model 50 and the classification model 51 in the nth iteration and trains the projection matrix An from the relationship between the input and the output of the classification model 51-n. The information processing apparatus 100 fine-tunes the natural language model 50-n and the classification model 51-n in the n+1th iteration and trains the projection matrix An+1 from the relationship between the input and the output of the classification model 51-n+1. Accordingly, the projection matrix A may be trained while the parameters of the entirety of the machine learning model 25 are updated.

The information processing apparatus 100 calculates the ground truth “Yₜ” by using the relationship between the projection matrix A and “Yₜ=A(A^{T})×Xₜ”. Accordingly, even in a case where the ground truth “Yₜ” corresponding to “Xₜ” is not prepared in advance, the classification model 51 may be fine-tuned.

The information processing apparatus 100 inputs “Xₜ” to the classification model 51 and updates the parameters of the classification model 51 such that the loss between “Y′ₜ” output from the classification model 51 and the ground truth “Yₜ” reduces. Accordingly, the accuracy of the machine learning model 55 may be improved.

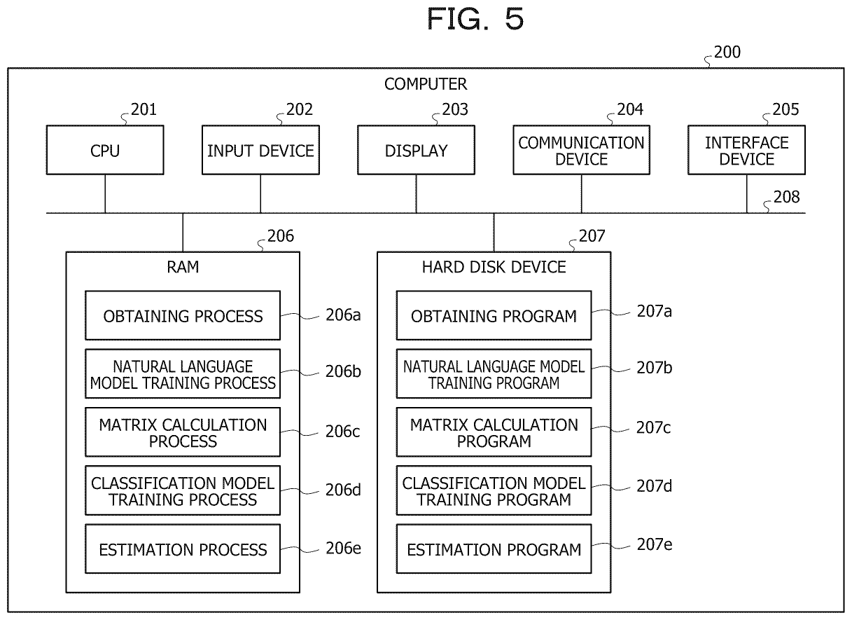

Next, an example of a hardware configuration of a computer that realizes the functions similar to those of the above-described information processing apparatus 100 is described. FIG. 5 is a diagram illustrating the example of the hardware configuration of the computer that realizes the functions similar to those of the information processing apparatus according to the embodiment.

As illustrated in FIG. 5, a computer 200 includes a CPU 201 that executes various types of computation process, an input device 202 that accepts input of data from a user, and a display 203. The computer 200 also includes a communication device 204 that exchanges data with the external apparatus or the like via a wired or wireless network and an interface device 205. The computer 200 also includes a random-access memory (RAM) 206 that temporarily stores various types of information and a hard disk device 207. Each of the devices 201 to 207 is coupled to a bus 208.

The hard disk device 207 includes an obtaining program 207a, a natural language model training program 207b, a matrix calculation program 207c, a classification model training program 207d, and an estimation program 207e. The CPU 201 reads each of the programs 207a to 207e and loads the programs into the RAM 206.

The obtaining program 207a functions as an obtaining process 206a. The natural language model training program 207b functions as a natural language model training process 206b. The matrix calculation program 207c functions as a matrix calculation process 206c. The classification model training program 207d functions as a classification model training process 206d. The estimation program 207e functions as an estimation process 206e.

Processing of the obtaining process 206a corresponds to the processing of the obtaining unit 151. Processing of the natural language model training process 206b corresponds to the processing of the natural language model training unit 152. Processing of the matrix calculation process 206c corresponds to the processing of the matrix calculation unit 153. Processing of the classification model training process 206d corresponds to the processing of the classification model training unit 154. Processing of the estimation process 206e corresponds to the processing of the estimation unit 155.

Each of the programs 207a to 207e is not necessarily stored in the hard disk device 207 from the beginning. For example, each program is stored in a “portable physical medium” such as a flexible disk (FD), a compact disk read-only memory (CD-ROM), a Digital Versatile Disc (DVD), a magneto-optical disk, or an integrated circuit (IC) card inserted into the computer 200. The computer 200 may read and execute each of the programs 207a to 207e.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A non-transitory computer-readable recording medium storing a machine learning program for causing a computer to execute a process for machine learning processing of a machine learning model in which a natural language processing model and a classification model are combined, the process comprising:
obtaining a first projection matrix that is obtained in an n-th iteration of the machine learning processing and that indicates a correspondence between input data inputted from the natural language processing model to the classification model and output data outputted from the classification model;
updating a parameter of the natural language processing model;
updating a parameter of the classification model by using the first projection matrix; and
obtaining, in an n+1-th iteration of the machine learning processing, a second projection matrix that indicates a correspondence between input data inputted from the updated natural language processing model to the updated classification model and output data outputted from the updated classification model,
wherein the n is a natural number.

2. The non-transitory computer-readable recording medium according to claim 1, wherein the output data outputted from the classification model is obtained based on the first projection matrix and the input data inputted to the classification model.

3. The non-transitory computer-readable recording medium according to claim 2, wherein, in the updating of the parameter of the classification model, the parameter of the classification model is updated based on an error between the obtained output data and the output data outputted from the classification model when the input data is inputted to the classification model.

4. A machine learning method for causing a computer to execute a process for machine learning processing of a machine learning model in which a natural language processing model and a classification model are combined, the process comprising:
obtaining a first projection matrix that is obtained in an n-th iteration of the machine learning processing and that indicates a correspondence between input data inputted from the natural language processing model to the classification model and output data outputted from the classification model;
updating a parameter of the natural language processing model;
updating a parameter of the classification model by using the first projection matrix; and
obtaining, in an n+1-th iteration of the machine learning processing, a second projection matrix that indicates a correspondence between input data inputted from the updated natural language processing model to the updated classification model and output data outputted from the updated classification model,
wherein the n is a natural number.

5. The machine learning method according to claim 4, wherein the output data outputted from the classification model is obtained based on the first projection matrix and the input data inputted to the classification model.

6. The machine learning method according to claim 5, wherein, in the updating of the parameter of the classification model, the parameter of the classification model is updated based on an error between the obtained output data and the output data outputted from the classification model when the input data is inputted to the classification model.

7. An information processing apparatus to execute a process for machine learning processing of a machine learning model in which a natural language processing model and a classification model are combined, the information processing apparatus comprising:
a memory; and
a processor coupled to the memory and configured to:
obtain a first projection matrix that is obtained in an n-th iteration of the machine learning processing and that indicates a correspondence between input data inputted from the natural language processing model to the classification model and output data outputted from the classification model;
update a parameter of the natural language processing model;
update a parameter of the classification model by using the first projection matrix; and
obtain, in an n+1-th iteration of the machine learning processing, a second projection matrix that indicates a correspondence between input data inputted from the updated natural language processing model to the updated classification model and output data outputted from the updated classification model,
wherein the n is a natural number.

8. The information processing apparatus according to claim 7, wherein the output data outputted from the classification model is obtained based on the first projection matrix and the input data inputted to the classification model.

9. The information processing apparatus according to claim 8, wherein, in the updating of the parameter of the classification model, the parameter of the classification model is updated based on an error between the obtained output data and the output data outputted from the classification model when the input data is inputted to the classification model.
